(19) United States
(12) Patent Application Publication
(10) Pub. No.: US 2011/0146160 A1
(43) Pub. Date: Jun. 23, 2011

(54) GLAZING WITH ENCASEMENT PIVOTALLY MOUNTED ABOUT AN AXIS IN A FIXED OPENING FRAME

(76) Inventor: Eric Joray, St-Aubin (CH)

(21) Appl. No.: 12/736,066

(22) PCT Filed: Mar. 3, 2009
(86) PCT No.: PCT/IB2009/050857

§ 371 Date: Nov. 8, 2010

(30) Foreign Application Priority Data
Mar. 3, 2008 (EP) 08102225.3

(51) Int. Cl. E06B 3/40; E06B 7/16; E05B 65/06

(52) U.S. Cl. 49/394

(57) ABSTRACT

In order to pivot the encasement provided with glass panes about the pivotal axis thereof in an opening frame, a mobile blade at the bottom of the frame is pressed down and the pivotal movement is initiated in one direction or the other after unlocking the spring blocks bearing the blades covering the grooves of the vertical profiles of the frame. The seal having a U profile slightly lifts the blade and the covering blade of the upper profile of the frame, whereby the pivoting of the frame is continued until, if the lower blade has been released in the meantime, the ledge of the flange of the upper profile of the encasement abuts the side edge of this same blade while the ribbed blade enters the opening of the U seal of the upper profile.

### TECHNICAL FIELD

The present invention relates to a glazing pivotally mounted about an axis in a fixed opening frame. It aims at providing a glazing liable to pivot by 180 degrees about its own axis and provided with sealing means and locking means which can be actuated in a closing position as well as in the opposite closing position of the glazing.

### STATE OF THE ART

The utilization of large glazed picture windows, which are more and more often used in the construction of buildings, meet some problems which have not been solved yet. Thus, when such picture windows are placed in height, cleaning, and more generally, any maintenance work to be carried out on the outer surface thereof, are often difficult and expensive. On the other hand, the manufacturing of glass presently offers the possibility of selectively manufacturing plates having various properties, for example, reflexion, energy transmission, light transmission, or transparency to infrared light, etc. It has thus been established that many of the mentioned problems could be solved by offering to position a pivoting glazing, so that it could pivot by 180 degrees about its axis, so that the surface previously outside would be inside. For example, an insulating glass having an energy transmission (value g) depending on the orientation thereof, in an optimized form, could allow significant money saving.

Glazed encasements which can pivot by 180 or 360 degrees are already known from documents CH 349 402 A and DE 39 43 123 C1.

### DISCLOSURE OF THE INVENTION

The aim of the invention is to provide a glazing provided with an encasement and mounted in a fixed opening frame, liable to pivot by 180 degrees, and offering safety and simplicity advantages for the handling as well as for the cleaning and maintenance operations with respect to the devices of the prior art.

For this purpose, the present invention relates to a set including a glazing provided with an encasement pivotally mounted about an axis in a fixed opening frame, and so arranged as to enable a pivoting angle of the glazing about said axis by 180 degrees, with means providing, on the one hand, the sealing and, on the other hand, the locking of the encasement with respect to the frame, characterized in that the fixed opening frame includes two frame elements having a quadrangular shape, with each one being formed with rectilinear segments of profiles and positioned against each other, one on the inside and the other one on the outside, in that said pivoting axis of the encasement is borne by the outside frame element, in that the glazing encasement includes segments of profiles provided with two opposite flanges, perpendicular to the plane of the glazing, symmetrical and each one being provided with a groove filled by a sealing member, with one flange being on the inside and the other one being on the outside of the glazing, and in that the inner element of the fixed frame of the set is provided with mobile flat blades, mounted on fixed segments of profiles, with the planes of said blades being perpendicular to the plane of the glazing and such blades cooperating, in the closing position, with said sealing members.

Other significant characteristics of the glazing of the invention are defined in the sub-claims, depending on claim 1.

### BRIEF DESCRIPTION OF THE DRAWINGS

One embodiment of the object of the invention is described hereinunder as an example thereof, while referring to the appended drawings, wherein:

FIG. 1 is a perspective view at a reduced scale, of the glazing, in the closed condition,

FIG. 2 is a view similar to FIG. 1 showing the glazing in open condition, at 90 degrees,

FIG. 3 is a shrunked cross sectional view along a vertical plane showing the elements of the glazing frame and encasement, in closed position,

FIG. 4 is a cross sectional view similar to FIG. 3 showing, still in closed condition, the frame and encasement elements in cross section along an horizontal plane,

FIG. 5 is a cross sectional view, along a plane parallel to the glazing, showing, at the same scale as FIGS. 3 and 4, the bottom right corner of the closed glazing, as seen from inside,

FIG. 6 is a front view of an exemplary spring block which can be used in the encasement shown in FIG. 3, and

FIGS. 7 and 8 are respectively a cross sectional view along line VII-VII and a top view of the block in FIG. 6.

### DETAILED DESCRIPTION OF THE EMBODIMENTS OF THE INVENTION

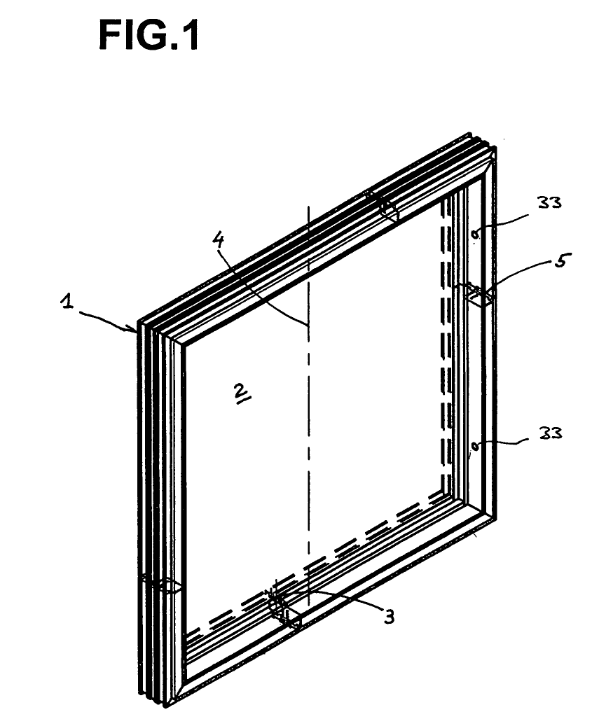

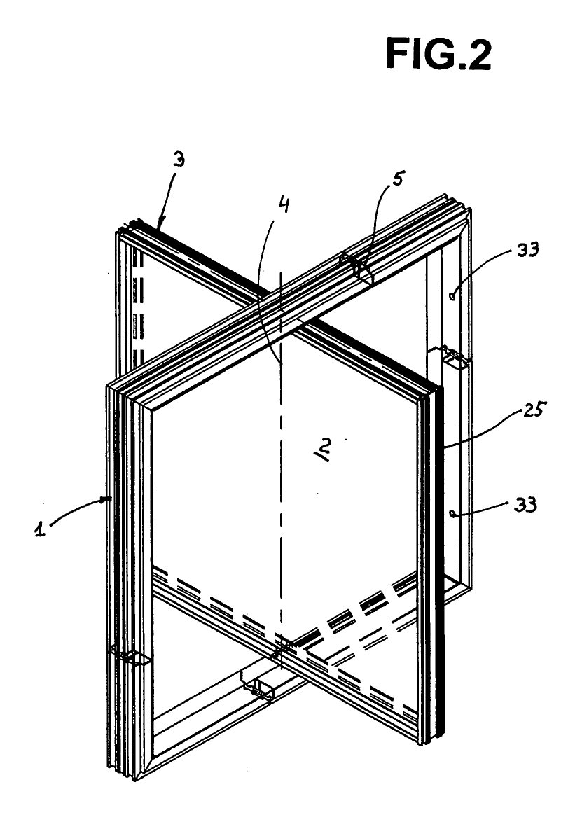

In FIGS. 1 and 2, the glazing is shown in respectively closed, and open at 90 degrees, positions, in its frame 1. The frame is fixed by conventional means in one opening of a wall, a window, a picture window which can be positioned at the lower level of a building as well as at a higher level. The glazing proper 2 is borne by an encasement 3 and pivots about an axis shown by the mixed line 4, which uses pivoting means which shall be described hereinafter. In the embodiment shown, the glazing has a rectangular shape and the pivoting axis is vertical and positioned in the middle of the base of the glazing, so that such glazing, when pivoting by 180 degrees, returns to the same initial position, since only the inner and outer faces have been swapped.

The frame 1 includes two adjacent elements attached to each other and each one being composed of four segments of profiles 5 made of a metal or another material, assembled as a quadrilateral, whereas the glazing encasement 3 includes only one element formed with four segments of profiles 25 assembled as a quadrilateral.

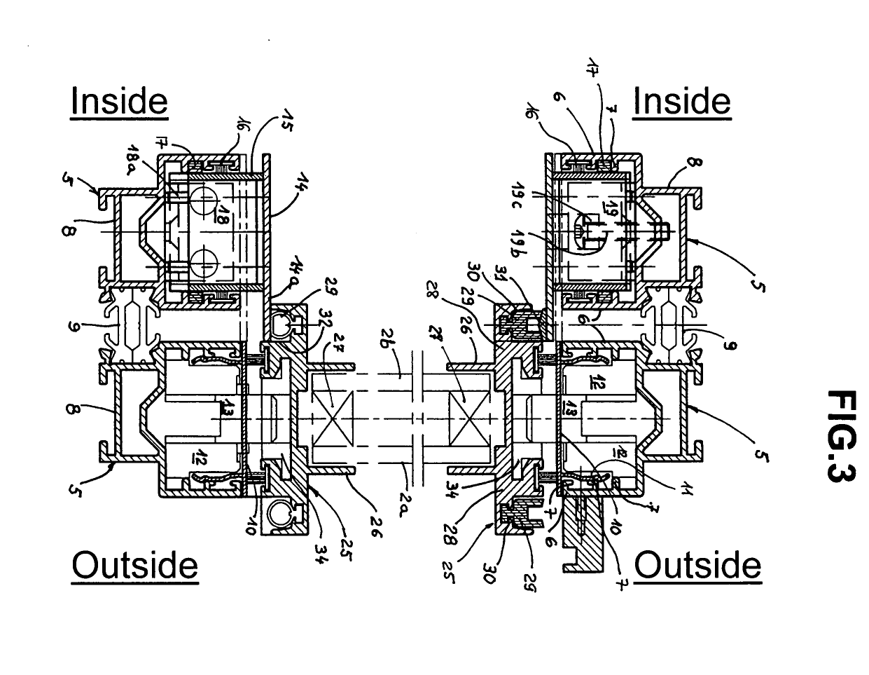

The elements of the frame 1 and of the encasement 3 can be seen, in cross section, in FIG. 3, as regards the upper and lower horizontal sides, and in FIG. 4 as regards the vertical sides. The segments of profiles 5 are rectilinear and assembled at the ends thereof, for example by riveting or any other means. The cross section of a profile 5 is that of a U, providing an open inner space intended for receiving prefabricated elements which will be described hereinafter. Such space is limited by two parallel flanges 6, the inside of which is provided with profile slides 7. At the base thereof, between the flanges, a structure 8 extends, which is designed for stiffening the profile and including a trapezoidal bar, two parallel walls and a plane bottom bar. The U-shaped profile of all the profiles 5 composing the two adjacent elements of the frame 1 opens on the inside, so that the structures 8 of the bottom of the profile can, for example, be buried in an anchoring system belonging to the encasement. In addition, the two adjacent elements of the frame 1 are assembled by intermediate seals 9 accommodated between the stiffening structures 8 and fixing the distance between the frame elements.

Prior to giving the description of the encasement element and of the glazing proper, we shall give the list of the added members which are provided on the grooves of the profiles 5 of the frame 1. As for the outer element of the frame 1, FIGS. 3 and 4 show that the profiles 5 are equipped with a covering blade 10 closing inwards the groove-shaped space of the profile. Such blades 10 are provided, outside, with elastic blades 11 bent so as to cling to the edges of one of the slides 7. However, as can be seen in FIG. 3, in the middle of the upper and lower sides of the element of the upper frame, the blades 10 are interrupted to give room to added rectangular blocks 12, and provided with fixed dowels 13 intended for pivoting the glazing frame.

As for the inner element of the frame 1, the profiles 5 thereof are provided with multiple auxiliary members intended for sealing the frame-encasement set and for locking the encasement 3. Thus, firstly, four blades 14 thicker than the blades 10 and movable perpendicularly to the profiles 5 which they top, extend on the whole length thereof. The inner edge of the blades 14 extends up to the limit of the inner faces of the walls 6 of the profiles 5. On the contrary, on the side adjoining the outer element of the frame, the blades 14 have a widening 14a, and the outer edge thereof extends up to the limit of the outer faces of the walls 6 of the profiles 5 belonging to the outer frame element. We shall see hereinafter that the blades 14 play the part of a mobile cover, with the side widening 14a playing a special part. A packing 31 is fixed on the widening of the blade 14 packing the profile 5 positioned horizontally with respect to the upper part of the frame 1 (FIG. 3). Such packing 31 is one to two millimeter thick and has a trapezoidal profile with a central rib.

Each one of the blades 14 is borne by two longitudinal ribs 15 integral with the blades and engaged between the walls 6 of the profiles in which they are mounted. Brushes 16 and beads made of synthetic material 17 are engaged between the walls 6 and the ribs 15 so as to guide the mobile covers 14, 15 in translation, perpendicularly to the profiles 5.

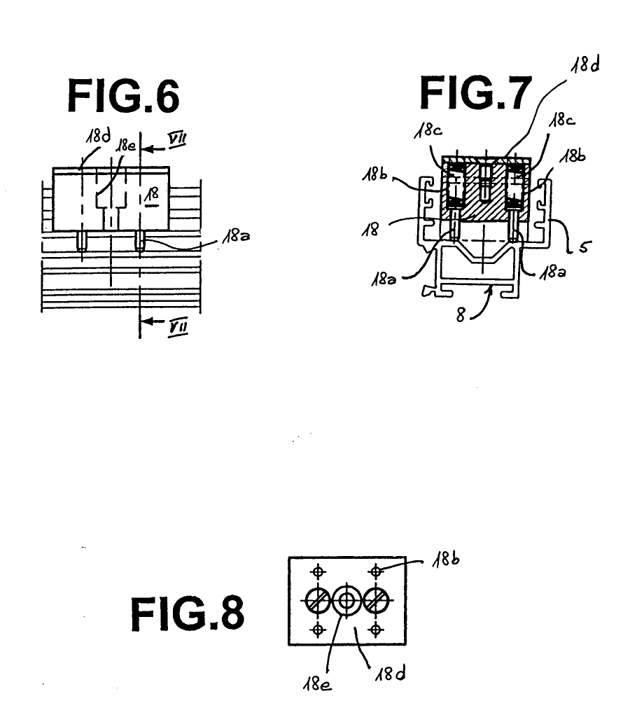

The strokes of the mobile covers 14, 15 are adjusted in different ways. The movements thereof are controlled by prefabricated members composed of spring blocks. In fact, such spring blocks can be executed in three different ways, as explained hereinunder. In the lower part of FIG. 3, a spring block 18 can be seen, a detailed example of construction of which is shown in FIGS. 6 to 8. Four flat head rods 18a are buried in the drills, with an internal shoulder, provided in a block 18 and actuated by springs held by a closing plate 18d. A body 18 having the shape of a rectangular parallelepiped is machined on all the faces thereof and has four cylindrical drills 18b, with an internal shoulder, located at the four angles of a rectangle in the upper face of the body 18. The four rods 18a, which can be flat headed pins, are engaged in the drills, so that the heads rest against the shoulders in the drills. Four springs 18c are engaged in the drills and held by a cover plate 18d screwed to the body using two screws in the central axis of the block, with each one on the line joining two springs 18c. It should be understood that the travel of the springs 18c, and consequently, the travel of the pins 18a, are selected so as to be able to give the blade 14 a given stroke between the lower position and the upper position thereof in which the bead 32 is compressed, as shown in solid lines in FIG. 3. A recess 18e provided at the centre of the plate 18d can be used for fixing the block 18 to the blade 14, if so required. The springs 18c can be replaced by any other appropriate elastic elements. Several spring blocks of the type 18 support the mobile cover 14, 15 placed horizontally at the base of the frame 1.

Spring blocks 19 are placed in the profile 5, on the upper side of the inner frame 1 element. The construction of such blocks is similar to that of the blocks 18, but are different on two points: on the one hand, the rods 19a are shorter than the rods 18a, so that the possible stroke of the blocks 19 is very limited, and on the other hand, each block 19 is held in the structure 8 of the profile 5 by an adjustable screw 19b, which can be adjusted using a cross-piece 19c. The possible stroke of the spring blocks 19 which control the top mobile plate 14, 15 is of the order of 1 to 3 mm. The rotation of the glazing, respectively of the profile 25, actuates the device in the vertical direction, through the “concave” section of the top seal 29 on the packing 31.

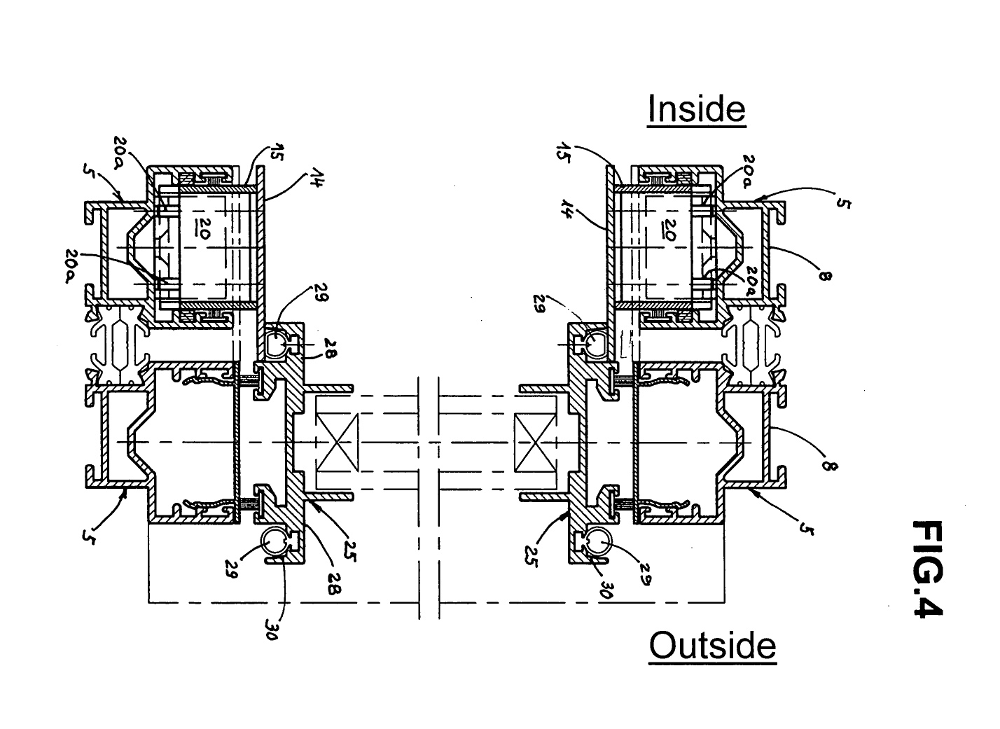

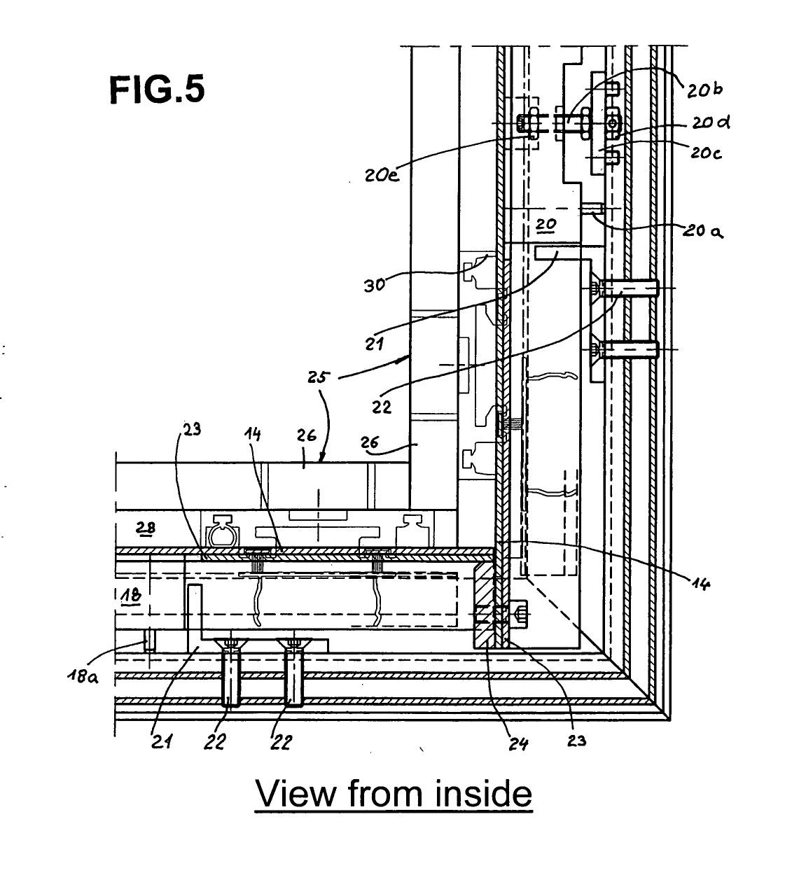

An alternative solution 20 for the described spring blocks is used in the profiles 5, which form the two vertical sides of the inner element of the frame 1 (refer to FIGS. 4 and 5). Such blocks 20 have larger dimensions, more particularly in length, than the blocks 18, and it can be seen, in FIG. 5, that they are provided, at the centre of the length thereof, with adjustment means by screwing, which enable to lock or unlock the encasement 3 at will. A threaded rod 20b (FIG. 5), the base of which includes a cylindrical segment rotating in a plate 20c goes through the block 20. Such set is fixed in the trapezoidal bar of the profile 5 structure 8, by a nut and a bolt 20d, but leaves enough clearance to allow it to rotate. The axial position of such rod is fixed by the nut and bolt 20d system, and the thread thereof goes through the block 20, so that the block 20 is moved in one direction or the other, in the central groove of the profile 5 delimited by the components 6, 6, and 8 thereof (FIGS. 3 and 4) when moving the rod 20b using an Allen key 6 through the corresponding opening 33 (FIG. 1). The nut 20e is a locking nut for which a socket wrench is necessary.

Several blocks 18, 19 and 20 can be positioned along the sides of the inner frame 1 element described here. Corner blocks 21 fixed by screws 22 guide these in the position thereof along the profiles 5 when they move perpendicularly to such profiles.

As can be seen further down, the blades 14 provided with the ribs 15, also called mobile covers, are so arranged as to provide the sealing of the glazing. A U-shaped stiffening profile 26, the ribs 15 of which are the flanges thereof (FIG. 5) is fixed on the whole length of the blades 14. Besides, stops 24 which play an essential part upon the locking, as will be seen in the following, are fixed on the lower ends of the two blades 14 provided on the vertical uprights of the frame 1 element.

The encasement 3 bearing the glazed equipment 2 is still to be described.

As can be seen in FIGS. 3, 4 and 5, the encasement 3 element is composed of four profile segments 25 assembled in a quadrilateral by the ends thereof. They each have two parallel flanges 26 oriented inwards the encasement 3, and used for guiding and holding two glass panes 2a and 2b, fixed to the encasement and held in position by cross-pieces 27. The profiles 25 further have two opposite flanges 28, perpendicular to the glazing plane and each provided with a groove 30 wherein a sealing joint 29 is buried. Such seals are of different structures: on the upper profile 25, which can be seen in FIG. 3, the seals 29 are segments of plastic material beads having a U-shaped profile, whereas on the other three profiles 25, which can be seen in FIGS. 3, 4 and 5, the seals 29 are segments of an elastic tube.

Finally, as can be seen in FIG. 3, the top and bottom profiles 25 are provided, in the middle of the length thereof, between the roots of the flanges 28, with a sectional plate 34 being provided with a hole which, upon assembling, engages on the dowels 13 to pivot the glazing.

The functions of the various components of the described device can easily be understood.

The Figures show the set in a locked position. To unlock and pivot the glazing 2, proceed as follows: first, control the screws 20b of the spring blocks 20, on the two vertical sides of the inner frame 1 element, so that the spring rods 20a are compressed. The vertical blades 14 move apart from the tubular joint 29. With same operation, stops 24 move apart and release the blade 14 on the lower side of the frame element 1. However, such blade will not move, since it is in a position which compresses the lower seal 29 of the encasement 3 (FIG. 3). The lower blade 14 must then simply be pressed to compress the spring rods 18a. As the spring blocks 19 have been adjusted beforehand, so that the upper blade 14 can slightly rise when the U-shaped seal 29 presses the ribbed blade 31, the pivoting motion of the encasement 3 can be initiated and continued either until an intermediate position, or until a complete 180 degrees rotation is reached.

When reaching 180 degrees, if the lower blade 14 has been released in the mean time, the inner flank 32 of the groove 30 opposite the one containing the tubular seal 29 previously compressed abuts against the widening 14a of the lower blade 14. Simultaneously, the U-shaped seal 29 releases the upper blade 14 bearing the ribbed blade 31, which fixes the final position of the glazing. Then the threaded rods 20b can be loosened again, which brings the vertical blades 14 back into the locking position and also locks the lower blade 14 in the position compressing the elastic seals, through the action of the stops 24.

The position described offers two types of advantages.

First, it facilitates the cleaning and maintenance of the outer glass panes, which can mean, for example in the higher levels of a building, a significant saving on costs as well as valuable security.

It further enables an interesting functional improvement in that, when the glass panes 2a and 2b have different optical properties, interesting effects as regards the insulation and the lighting of rooms inside the building can be obtained. For example, if one of the faces of one of the plates 2a or 2b has particularly significant infrared light reflecting properties, the glazing can thus be turned so that such face is exposed to the sun in summer, so as to reduce the heating of the rooms inside, whereas such face will facilitate heating if it is turned inwards.

It should be noted that the pivoting axis of the glazing according to the invention need not be vertical. A glazing with a horizontal axis can also be provided, as explained above, with pivoting, locking and sealing means as described hereabove.

1. A set including a glazing provided with an encasement pivotally mounted about an axis in a fixed opening frame, and so arranged as to enable a pivoting angle of the glazing about said axis by 180 degrees, with means providing, on the one hand, the sealing and, on the other hand, the locking of the encasement with respect to the frame, characterized in that the fixed opening frame includes two frame elements having a quadrangular shape, with each one being formed with rectilinear segments of profiles and positioned against each other, one on the inside and the other one on the outside, in that said pivoting axis of the encasement is borne by the outside frame element, in that the glazing encasement includes segments of profiles provided with two opposite flanges, perpendicular to the plane of the glazing, symmetrical and each one being provided with a groove filled by a sealing member, with one flange being on the inside and the other one being on the outside of the glazing, and in that the inner element of the fixed frame of the set is provided with mobile flat blades, mounted on fixed segments of profiles, with the planes of said blades being perpendicular to the plane of the glazing and such blades cooperating in the closing position with said sealing members.

2. A set according to claim 1, characterized in that said mobile blades are borne, in said profiles, by prefabricated elements provided with elastic elements.

3. A set according to claim 2, characterized in that said prefabricated elements are blocks wherein are accommodated rods protruding on one face of the block and actuated by springs, each one of said mobile blades being borne by several said blocks.

4. A set according to claim 1, characterized in that the elements of the encasement frame each have two parallel flanges which hold at least two glass panes having different properties enabling the glazing to operate either as a member reflecting the sun radiation, in summer, or as an insulating member, from the inside to the outside, in winter, depending on the orientation of the encasement in the opening frame, so as to improve the quality of the partitioned climate and to reduce energy costs.

5. A set according to claim 1, characterized in that said sealing members include tubular seals engaged in said grooves of the flanges on several sides of said element or, on at least one side, in the form of segments of an elastic seal having a U profile also engaged in the grooves of the flanges.

6. A set according to claim 1, characterized in that said mobile flat blades of the opening frame (1) are borne by prefabricated spring blocks engaged and guided into U-shaped grooves opening onto the centre of the frame, provided on the four segments of profiles forming the inner element of the frame.

7. A set according to claim 1, characterized in that said sealing means of the opening frame include, on each one of said mobile blades, a side widening extending along the edge of such blade, which is adjacent to the inner flange of the glazing encasement profile, such widening being so arranged that, as it is moved together with the blade which it belongs to toward the centre of the frame by the actuation of the spring blocks, it presses, in the closing position of the encasement, on the tubular seals of three sides of the encasement, and, on the fourth side, through a ribbed seal packing which is fixed thereto, on the opening of a segment of a U-shaped seal engaged in the groove of the inner flange of the encasement.

8. A set according to claim 1, characterized in that said locking means include, on two sides of the opening frame parallel to the pivoting axis of the glazing, prefabricated locking members provided with spring blocks, including screwable bolts engaged in said spring blocks and pressing on the bottom of the grooves of the frame profiles, such locking members enabling to lock said mobile blades in abutting positions of the side edges thereof against one of the ledges provided by the flanges of the encasement element, by compressing an elastic tubular seal.

9. A set according to claim 8, characterized in that said locking means include, on at least one end of the mobile blades whereon said locking means act, locking bars which, in locking position, engage under the ends of a mobile blade accommodated on the lower side of the frame, in order to also lock such blade accommodated on the lower side.
